(19) United States
(12) Patent Application Publication
(10) Pub. No.: US 2026/0119380 A1
(43) Pub. Date: Apr. 30, 2026

(54) REAL-TIME SIMULATION AND VISUALIZATION OF BEHAVIOR OF ARTIFICIAL INTELLIGENCE (AI) AGENTS FOR PERFORMANCE OPTIMIZATION

(71) Applicant: BOOMI, LP, Conshohocken, PA (US)

(72) Inventors: Ayush PARASHAR, Foster City, CA (US); Lomesh AGRAWAL, Bangalore (IN); Swagata ASHWANI, San Francisco, CA (US); Dipti RATHI, Bengaluru (IN); Ashish Kumar MISHRA, Uttar Pradesh (IN)

(73) Assignee: BOOMI, LP, Conshohocken, PA (US)

(21) Appl. No.: 19/367,464

(22) Filed: Oct. 23, 2025

(30) Foreign Application Priority Data
Oct. 25, 2024 (IN) 202411081537
Oct. 25, 2024 (IN) 202411081538

(51) Int. Cl. G06F 11/3668; G06F 30/20

(52) U.S. Cl. CPC G06F 11/3688; G06F 11/3696; G06F 30/20; G06F 2201/81; G06F 2201/865

(57) ABSTRACT

Existing platforms for developing artificial intelligence (AI) agents rely on static testing or limited real-world scenarios to evaluate agentic behavior. Accordingly, a simulator is disclosed that enables the simulation of an AI agent with adaptive test scenarios. During the simulation, a visualization interface may display a trace of the behavioral flow of the AI agent in real time. The simulator may also monitor and display one or more performance metrics and provide indications of the guardrail compliance of the AI agent in real time. A user may also pause, rewind, or modify the simulation in real time, to make immediate and real-time adjustments to the configuration of the AI agent.

### CROSS-REFERENCE TO RELATED APPLICATIONS

The present application claims priority to Indian Patent Application number 202411081537, filed on Oct. 25, 2024, and Indian Patent Application number 202411081538, filed on Oct. 25, 2024, which are both hereby incorporated herein by reference as if set forth in full.

### BACKGROUND

### Field of the Invention

The embodiments described herein are generally directed to artificial intelligence (AI), and, more particularly, to the real-time simulation and visualization of the behavior of AI agents for performance optimization.

### Description of the Related Art

A number of platforms exist that enable users to construct artificial intelligence (AI) agents. An AI agent is a software entity that utilizes artificial intelligence to autonomously perform one or more tasks, in order to achieve an objective set by a human, another software entity (e.g., another AI agent), or other system. An AI agent may comprise or communicate with one or more integrated, local, or remote AI models, such as generative AI models (e.g., generative language models, generative image models, generative coding models, etc.). An AI agent may also communicate with one or more tools that are external to the AI agent, to complete tasks in furtherance of its objective. The AI agent may communicate with an AI model and/or tool using an application programming interface (API).

Existing platforms for the development of AI agents typically rely on static testing environments or limited real-world scenarios to evaluate the AI agents' behaviors. Such an approach often fails to capture the full range of potential agentic responses across diverse use cases. This may lead to unexpected behaviors or errors when AI agents are deployed in production environments. What is needed is a platform that provides a comprehensive simulation environment that enables developers to test AI agents against a wide range of scenarios in real time, visualize the decision-making process, identify potential problems before deployment, and refine agentic configurations based on the simulation results.

### SUMMARY

Accordingly, systems, methods, and non-transitory computer-readable media are disclosed for real-time simulation and visualization of the behavior of AI agents for performance optimization.

In an embodiment, a method comprises using at least one hardware processor to: instantiate an artificial intelligence (AI) agent within a simulation environment; and execute the AI agent in each of a plurality of test scenarios within the simulation environment, while, in real time, updating a graphical user interface that comprises a graphical representation of a behavioral flow of the AI agent during the execution of the AI agent, wherein the graphical representation of the behavioral flow comprises a plurality of visual elements that each represents one of a plurality of events in the behavioral flow.

The method may further comprise using the at least one hardware processor to, during the execution of the AI agent, collect one or more performance metrics of the execution of the AI agent, wherein the graphical user interface comprises a value of each of the one or more performance metrics. The one or more performance metrics may comprise at least one of a response time, decision accuracy, or resource utilization.

Executing the AI agent in each of the plurality of test scenarios may comprise, for each of at least a subset of the plurality of test scenarios: submitting an input, defined by the test scenario, to the AI agent; receiving an output, responsive to the input, from the AI agent; and monitoring a decision-making process of the AI agent from the submission of the input to the reception of the output. The method may further comprise using the at least one hardware processor to, during the execution of the AI agent, for each of the at least a subset of the plurality of test scenarios: evaluate the decision-making process against one or more guardrails; determine whether or not the decision-making process violates at least one of the one or more guardrails; and when determining that the decision-making process violates at least one guardrail, report the violation within the graphical user interface. The plurality of test scenarios may comprise at least one test scenario that attempts to force the AI agent beyond a boundary established by the at least one guardrail. Determining whether or not the decision-making process violates the at least one guardrail may comprise determining whether or not the decision-making process is compliant with each of a plurality of regulatory frameworks. Determining whether or not the decision-making process is compliant with each of a plurality of regulatory frameworks may comprise, for each of the plurality of regulatory frameworks: generating a compliance score for the regulatory framework based on the decision-making process; and determining whether or not the compliance score satisfies a threshold.

The method may further comprise using the at least one hardware processor to determine the plurality of test scenarios. Determining the plurality of test scenarios may comprise receiving a selection of at least a subset of the plurality of test scenarios from a library of scenarios. Determining the plurality of test scenarios may comprise receiving a definition of each of at least a subset of the plurality of test scenarios from a user. Receiving a definition of each of the at least a subset of the plurality of test scenarios may comprise receiving a value of each of one or more parameters of a predefined scenario template. Each of the plurality of test scenarios may be represented by a workflow, wherein receiving a definition of each of the at least a subset of the plurality of test scenarios comprises receiving, via the graphical user interface, a definition of the workflow, representing that test scenario, as a plurality of nodes, representing steps in the workflow, connected by directed edges, representing progressions between steps in the workflow.

The graphical user interface may comprise one or more inputs for one or both of pausing or rewinding the behavioral flow of the AI agent in each of the plurality of test scenarios. The method may further comprise using the at least one hardware processor to, during the execution of the AI agent: receive a modification of the AI agent; and execute the modified AI agent in each of at least a subset of the plurality of test scenarios within the simulation environment, while, in real time, updating the graphical user interface.

The graphical user interface may comprise a first screen, wherein the first screen comprises a conversational frame and an informational frame. The conversational frame may comprise one or more inputs to the AI agent, and for each of the one or more inputs, a respective output of the AI agent. The conversational frame may further comprise an input for submitting a new input to the AI agent, wherein each submission of a new input is added as a new test scenario to the plurality of test scenarios. The informational frame may comprise an entry for each of the plurality of test scenarios, wherein each entry for one of the plurality of test scenarios comprises an input for specifying an expected output of the AI agent in that one test scenario.

The plurality of visual elements may comprise nodes, representing the plurality of events, that are connected by directed edges, representing progressions between the plurality of events.

It should be understood that any of the features in the methods above may be implemented individually or with any subset of the other features in any combination. Thus, to the extent that the appended claims would suggest particular dependencies between features, disclosed embodiments are not limited to these particular dependencies. Rather, any of the features described herein may be combined with any other feature described herein, or implemented without any one or more other features described herein, in any combination of features whatsoever. In addition, any of the methods, described above and elsewhere herein, may be embodied, individually or in any combination, in executable software modules of a processor-based system, such as a server, and/or in executable instructions stored in a non-transitory computer-readable medium.

### BRIEF DESCRIPTION OF THE DRAWINGS

The details of the present invention, both as to its structure and operation, may be gleaned in part by study of the accompanying drawings, in which like reference numerals refer to like parts, and in which:

FIG. 1 illustrates an example infrastructure, in which one or more of the processes described herein may be implemented, according to an embodiment;

FIG. 2 illustrates an example processing system, by which one or more of the processes described herein may be executed, according to an embodiment;

FIG. 3 illustrates an example data flow for real-time simulation and visualization of the behavior of artificial intelligence (AI) agents for performance optimization, according to an embodiment;

FIG. 4 illustrates an example process for real-time simulation and visualization of the behavior of AI agents for performance optimization, according to an embodiment; and

FIGS. 5A-5E illustrate example screens of a graphical user interface, according to an embodiment.

### DETAILED DESCRIPTION

Embodiments of systems, methods, and non-transitory computer-readable media are disclosed for real-time simulation and visualization of the behavior of AI agents for performance optimization. After reading this description, it will become apparent to one skilled in the art how to implement the invention in various alternative embodiments and alternative applications. However, although various embodiments of the present invention will be described herein, it is understood that these embodiments are presented by way of example and illustration only, and not limitation. As such, this detailed description of various embodiments should not be construed to limit the scope or breadth of the present invention as set forth in the appended claims.

### 1. INFRASTRUCTURE

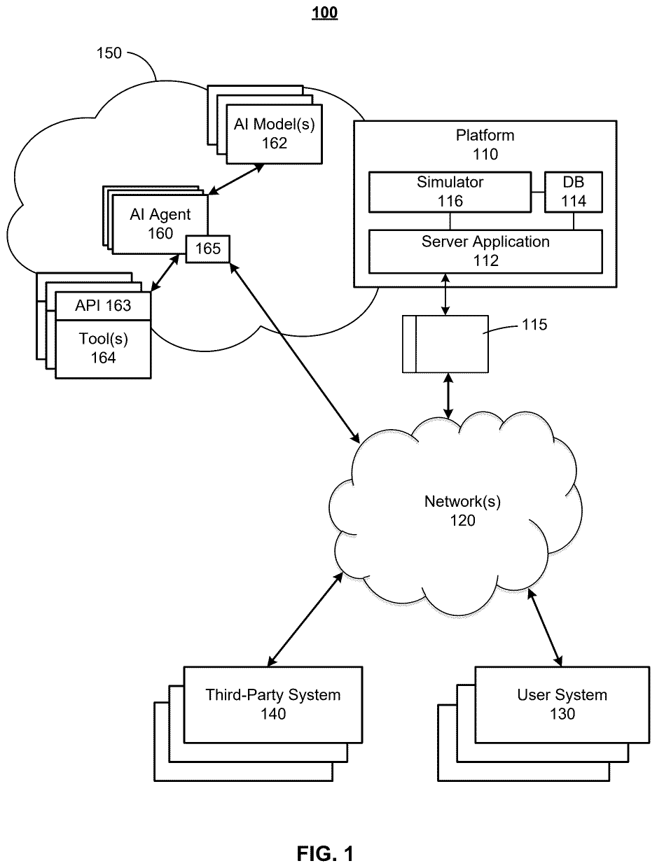

FIG. 1 illustrates an example infrastructure 100, in which one or more of the processes described herein may be implemented, according to an embodiment. Infrastructure 100 may comprise a platform 110 which hosts, supports, and/or executes one or more of the disclosed processes, which may be implemented in software and/or hardware. In particular, platform 110 may execute a server application 112 and/or a simulator 116. Platform 110 may also host a database 114 that may store data used and/or produced by server application 112 and/or simulator 116. Platform 110 may comprise dedicated servers, or may instead be implemented in a computing cloud, in which the resources of one or more servers are dynamically and elastically allocated to multiple tenants based on demand. In either case, the servers may be collocated and/or geographically distributed.

Platform 110 may be communicatively connected to one or more networks 120. Network(s) 120 enable communication between platform 110 and one or more user systems 130 and/or third-party systems 140. Network(s) 120 may comprise the Internet, and communication through network(s) 120 may utilize standard transmission protocols, such as HTTP, HTTP Secure (HTTPS), File Transfer Protocol (FTP), FTP Secure (FTPS), Secure Shell FTP (SFTP), and the like, as well as proprietary protocols. While platform 110 is illustrated as being connected to a plurality of user systems 130 and/or third-party system(s) 140 through a single set of network(s) 120, it should be understood that platform 110 may be connected to different user systems 130 and/or third-party systems 140 via different sets of one or more networks. For example, platform 110 may be connected to a subset of user systems 130 and/or third-party systems 140 via the Internet, but may be connected to another subset of user systems 130 and/or third-party systems 140 via an intranet.

While only a few user systems 130 are illustrated, it should be understood that platform 110 may be communicatively connected to any number of user system(s) 130 via network(s) 120. User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, and/or the like. However, it is generally contemplated that a user system 130 would be the personal computer or professional workstation of a manager or developer of artificial intelligence (AI) agents 160, who has a user account for accessing server application 112 on platform 110. It should be understood that the user may be anywhere from an expert software engineer, with extensive knowledge of AI agents, to a business decision-maker, lay person, or other non-technical person, with little to no knowledge of AI agents. Each user account may be associated with an overarching organizational account for managing software entities, including AI agents 160.

Server application 112 may manage a computing environment 150. In particular, server application 112 may provide a user interface 115 and backend functionality, including one or more of the processes disclosed herein, to enable or otherwise support users, via user systems 130, to construct, develop, modify, save, delete, test, deploy, un-deploy, and/or otherwise manage software entities within computing environment 150. User interface 115 may comprise a graphical user interface that implements a low-code environment, including potentially a no-code environment, in which users may construct software entities. These software entities may comprise AI agents 160, and potentially other software entities, such as integration processes.

The user of a user system 130 may authenticate with platform 110 using standard authentication means, to access server application 112 and/or simulator 116 in accordance with roles or permissions of the associated user account. The user may then interact with server application 112 and/or simulator 116 to manage one or more software entities, for example, within a larger software platform within computing environment 150. It should be understood that multiple users, on multiple user systems 130, may manage the same software entities and/or different software entities in this manner, according to the permissions or roles of their associated user accounts.

In an embodiment, platform 110 may be an integration platform as a service (iPaaS) platform. In this case, the software entities(s) being developed may include integration process(es). Computing environment 150 may comprise one or a plurality of integration platforms that each comprises one or a plurality of integration processes. Each integration platform may be associated with an organization, which may be associated with one or more user accounts by which respective user(s) manage the organization's integration platform, including the various integration process(es). An integration process may represent a transaction involving the integration of data between two or more systems, and may comprise a series of elements that specify logic and transformation requirements for the data to be integrated. Each element, which may also be referred to as a “step,” may transform, route, and/or otherwise manipulate data to attain an end result from input data. For example, a basic integration process may receive data from one or more data sources (e.g., via an application programming interface of the integration process), manipulate the received data in a specified manner (e.g., including mapping, analyzing, normalizing, altering, updating, enhancing, and/or augmenting the received data), and send the manipulated data to one or more specified destinations (e.g., via an application programming interface of each destination). An integration process may represent a business workflow or a portion of a business workflow or a transaction-level interface between two systems, and comprise, as one or more elements, software modules that process data to implement the business workflow or interface. A business workflow may comprise any myriad of workflows of which an organization may repetitively have need. For example, a business workflow may comprise, without limitation, procurement of parts or materials, manufacturing a product, selling a product, shipping a product, ordering a product, billing, managing inventory or assets, providing customer service, ensuring information security, marketing, onboarding or offboarding an employee, assessing risk, obtaining regulatory approval, reconciling data, auditing data, providing information technology services, and/or any other workflow that an organization may implement in software. These integration processes, and/or the development and/or management of these integration processes, may be supported by one or more AI agents 160, and/or the integration processes may support AI agents 160, for example, as tools 164 that are utilized by AI agents 160.

Each AI agent 160 and/or integration process, when deployed, may be communicatively coupled to network(s) 120. For example, each AI agent 160 and/or integration process may comprise an application programming interface (API) that enables clients to access the software entity via network(s) 120. For instance, AI agent 160 comprises an agentic interface 165 that may comprise or consist of an application programming interface. A client may push data to an AI agent 160 and/or integration process through the application programming interface, and/or pull data from AI agent 160 and/or an integration process through the application programming interface.

In some cases, an AI agent 160 may be a conversational AI agent. In this case, AI agent 160 may implement a chat interface, within agentic interface 165. The chat interface may be comprised or embedded (e.g., as an overlaid chat frame) within user interface 115. Alternatively, the chat interface may be separate and distinct from user interface 115. The chat interface may comprise a graphical user interface, an audio interface, or a combination of graphical and audio user interface (i.e., an audiovisual interface).

One or more third-party systems 140 may be communicatively connected to network(s) 120, such that each third-party system 140 may communicate with an AI agent 160 and/or integration process in computing environment 150 via an application programming interface. Third-party system 140 may host and/or execute a software application that pushes data to an AI agent 160 and/or integration process and/or pulls data from an AI agent 160 and/or integration process, via the application programming interface of the AI agent 160 or integration process. Additionally or alternatively, an AI agent 160 and/or integration process may push data to a software application on third-party system 140 and/or pull data from a software application on third-party system 140, via an application programming interface of the third-party system 140. Thus, third-party system 140 may be a client or consumer of one or more AI agents 160 and/or integration processes, a data source for one or more AI agents 160 and/or integration processes, and/or the like. As examples, the software application on third-party system 140 may comprise, without limitation, enterprise resource planning (ERP) software, customer relationship management (CRM) software, accounting software, and/or the like.

As discussed above, the software entities(s) being developed and/or otherwise managed on platform 110 may include AI agents 160. An AI agent 160 is any software entity that utilizes artificial intelligence (e.g., machine learning, natural-language processing, data analytics, etc.), embodied in one or more AI models 162, to autonomously perform a task, in order to achieve an objective set by a human, other software entity, or other system. AI agent 160 may collect data, analyze data, communicate with human users and/or other software entities, collaborate with other AI agents 160 to complete a complex task, execute actions, learn and improve over time, and/or the like. Although only a few AI agents 160 are illustrated, it should be understood that computing environment 150 may comprise any number of AI agents 160, including hundreds, thousands, tens of thousands, hundreds of thousands, millions, tens of millions, hundreds of millions, billions, tens of billions, hundreds of billions, or more AI agents 160. For the sake of simplicity, an AI agent 160 may also be referred to herein simply as an “agent,” and the term “agentic” is an adjective that indicates that the modified noun pertains to an AI agent 160.

Each AI agent 160 comprises or is communicatively coupled to at least one AI model 162. AI model 162 may be internal to AI agent 160, external but local (i.e., within computing environment 150) to AI agent 160, or external and remote (i.e., outside computing environment 150, e.g., hosted on third-party system 140, etc.) from AI agent 160. An AI model 162 may be a generative AI model, such as a generative language model (e.g., small language model, large language model, etc., that responds to natural-language prompts in natural language), generative image model (e.g., that responds to natural-language prompts with an image), generative video model (e.g., that responds to natural-language prompts with a video), generative coding model (e.g., that responds to natural-language prompts with software code), or the like. As used herein, the term “natural language” or “natural-language” refers to language, including grammar, that would be expected in a normal conversation between two humans. A pre-trained generative AI model may be used as a base model that is fine-tuned for the specific task of AI agent 160, to produce AI model 162.

One well-known example of a large language model is the Generative Pre-trained Transformer (GPT). GPT-4 is the fourth-generation language prediction model in the GPT-n series, created by OpenAI of San Francisco, California. GPT-4 is an autoregressive language model that uses deep learning to produce human-like text. GPT-4 has been pre-trained on a vast amount of text from the open Internet. While GPT-4 is provided as an example, it should be understood that the generative language model may be any generative language model, including past and future generations of GPT, as well as other large language models, such as any of the DeepSeek family of large language models from DeepSeek AI of Hangzhou, Zhejiang, China, any of the Claude family of large language models (e.g., Claude Opus, Claude Sonnet, etc.) developed by Anthropic PBC of San Francisco, California, the Falcon large language model (e.g., Falcon 160B) released by the United Arab Emirates' Technology Innovation Institute (TII), the Large Language Model Meta AI (LLaMA) model (e.g., LLaMA 2) released by Meta AI of New York, New York, any of the Gemini family of large language models from Google LLC of Mountain View, California, any of the Mistral family of models released by Mistral AI of Paris, France, and the like.

Examples of generative image models include, without limitation, the DALL-E family of models (e.g., DALL-E, DALL-E 2, or DALL-E 3) from OpenAI, Stable Diffusion (e.g., SD 3.5) from Stability AI Ltd of London, England, United Kingdom, Imagen (e.g., Imagen 3) from Google LLC of Mountain View, California, Midjourney form Midjourney, Inc. of San Francisco, California, Adobe Firefly from Adobe Inc. of San Jose, California, Picasso from Nvidia Corp. of Santa Clara, California, Runway Gen-2 from Runway AI, Inc. of New York City, New York, and the like. Examples of generative video models include, without limitation, Runway Gen-2, the Pika family of models from Pika Labs AI of San Francisco, California, Lumiere from Google LLC, VideoLDM from Nvidia, Make-A-Video from Meta Platforms, Inc. of Menlo Park, California, Synthesia from Synthesia of London, England, United Kingdom, DeepBrain AI from AI Studios of Palo Alto, California, Stable Video Diffusion from Stability AI Ltd, and the like.

Examples of generative coding models include, without limitation, Codex from OpenAI, AlphaCode from Google LLC, Code LLAMA from Meta AI, AlphaFold Code from DeepMind Technologies Limited of London, England, United Kingdom, CodeWhisperer from Amazon Web Services of Seattle, Washington, CodeGen from Salesforce, Inc. of San Francisco, California, StarCoder developed by Hugging Face and ServiceNow Research, Tabnine from Tabnine of Tel Aviv, Israel, and the like.

Each AI agent 160 may comprise or be communicatively coupled to zero, one, or a plurality of tools 164. Tool(s) 164 may be hosted within computing environment 150 (e.g., a cloud-computing environment) and/or externally to computing environment 150 (e.g., on a third-party system 140). AI agent 160 may communicate with a tool 164 via an application programming interface 163 of that tool 164. Application programming interface 163 may provide one or more operations that can be performed by AI agent 160 using the respective tool 164. Each operation may accept zero, one, or a plurality of parameters as input and/or return an output that comprises data representing a response, an acknowledgement, and/or the like. An operation, which may also be referred to herein as an “endpoint,” may be defined by a base Uniform Resource Locator (URL), a path that indicates the resource or action being requested, an HTTP method defining the action to be performed (e.g., GET, POST, PUT, DELETE, etc.), zero, one, or more request parameters, a response format, an authentication or security protocol, a version number, rate limits, error handling, and/or the like.

Tools 164 enable an AI agent 160 to interact with external systems, and even potentially, the physical world. Each tool 164 may perform a task for the overall objective of AI application 160. A task may comprise retrieving data from a source (e.g., another software entity, a local database hosted within computing environment 150, a remote database hosted externally to computing environment 150, a third-party system, application, or database, an integration process, a knowledge base, etc.), transforming, formatting, mapping, cleaning, or otherwise manipulating data, analyzing data, storing data, sending data (e.g., tabular or other structured data, unstructured data, commands, requests, queries, etc.) to a destination (e.g., another software entity, a local database, a remote database, a third-party system, application, or database, an integration process, knowledge base, etc.), initiating a transaction (e.g., purchase, sale, exchange, trade, etc.), completing a transaction, actuating a physical device (e.g., activate a motor, switch, or other machine component, set or adjust a setpoint for a control parameter, etc.), and/or the like.

### 2. EXAMPLE PROCESSING SYSTEM

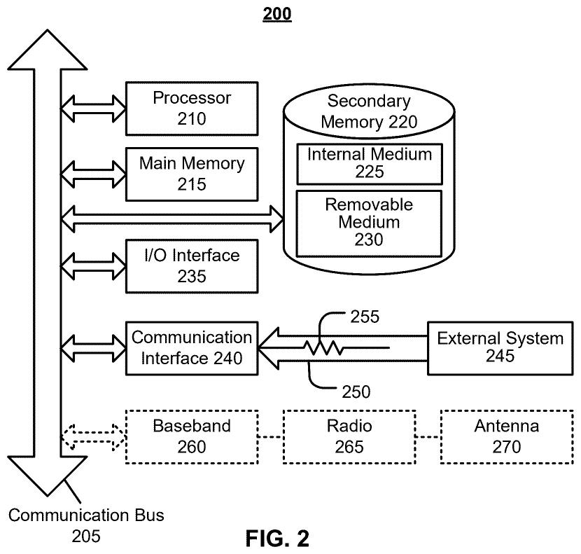

FIG. 2 illustrates an example processing system 200, by which one or more of the processes described herein may be executed, according to an embodiment. For example, system 200 may be used to store and/or execute server application 112, simulator 116, AI agent 160, AI model(s) 162, tool(s) 164, and/or may represent components of platform 110, user system(s) 130, third-party system(s) 140, and/or other processing devices described herein. System 200 can be any processor-enabled device (e.g., server, personal computer, etc.) that is capable of wired or wireless data communication. Other processing systems and/or architectures may also be used, as will be clear to those skilled in the art.

System 200 may comprise one or more processors 210. Processor(s) 210 may comprise a central processing unit (CPU). Additional processors may be provided, such as a graphics processing unit (GPU), an auxiliary processor to manage input/output, an auxiliary processor to perform floating-point mathematical operations, a special-purpose microprocessor having an architecture suitable for fast execution of signal-processing algorithms (e.g., digital-signal processor), a subordinate processor (e.g., back-end processor), an additional microprocessor or controller for dual or multiple processor systems, and/or a coprocessor. Such auxiliary processors may be discrete processors or may be integrated with a main processor 210. Examples of processors which may be used with system 200 include, without limitation, any of the processors (e.g., Pentium™, Core i7™, Core i9™, Xeon™, etc.) available from Intel Corporation of Santa Clara, California, any of the processors available from Advanced Micro Devices, Incorporated (AMD) of Santa Clara, California, any of the processors (e.g., A series, M series, etc.) available from Apple Inc. of Cupertino, any of the processors (e.g., Exynos™) available from Samsung Electronics Co., Ltd., of Seoul, South Korea, any of the processors available from NXP Semiconductors N.V. of Eindhoven, Netherlands, any of the processors available from Nvidia Corporation of Santa Clara, California, and/or the like.

Processor(s) 210 may be connected to a communication bus 205. Communication bus 205 may include a data channel for facilitating information transfer between storage and other peripheral components of system 200. Furthermore, communication bus 205 may provide a set of signals used for communication with processor 210, including a data bus, address bus, and/or control bus (not shown). Communication bus 205 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and/or the like.

System 200 may comprise main memory 215. Main memory 215 provides storage of instructions and data for programs executing on processor 210, such as any of the software discussed herein. It should be understood that programs stored in the memory and executed by processor 210 may be written and/or compiled according to any suitable language, including without limitation C/C++, Java, JavaScript, Perl, Python, Visual Basic, .NET, and the like. Main memory 215 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

System 200 may comprise secondary memory 220. Secondary memory 220 is a non-transitory computer-readable medium having computer-executable code and/or other data (e.g., any of the software disclosed herein) stored thereon. In this description, the term “computer-readable medium” is used to refer to any non-transitory computer-readable storage media used to provide computer-executable code and/or other data to or within system 200. The computer software stored on secondary memory 220 is read into main memory 215 for execution by processor 210. Secondary memory 220 may include, for example, semiconductor-based memory, such as programmable read-only memory (PROM), erasable programmable read-only memory (EPROM), electrically erasable read-only memory (EEPROM), and flash memory (block-oriented memory similar to EEPROM).

Secondary memory 220 may include an internal medium 225 and/or a removable medium 230. Internal medium 225 and removable medium 230 are read from and/or written to in any well-known manner. Internal medium 225 may comprise one or more hard disk drives, solid state drives, and/or the like. Removable storage medium 230 may be, for example, a magnetic tape drive, a compact disc (CD) drive, a digital versatile disc (DVD) drive, other optical drive, a flash memory drive, and/or the like.

System 200 may comprise an input/output (I/O) interface 235. I/O interface 235 provides an interface between one or more components of system 200 and one or more input and/or output devices. Examples of input devices include, without limitation, sensors, keyboards, touch screens or other touch-sensitive devices, cameras, biometric sensing devices, computer mice, trackballs, pen-based pointing devices, and/or the like. Examples of output devices include, without limitation, other processing systems, cathode ray tubes (CRTs), plasma displays, light-emitting diode (LED) displays, liquid crystal displays (LCDs), printers, vacuum fluorescent displays (VFDs), surface-conduction electron-emitter displays (SEDs), field emission displays (FEDs), and/or the like. In some cases, an input and output device may be combined, such as in the case of a touch-panel display (e.g., in a smartphone, tablet computer, or other mobile device).

System 200 may comprise a communication interface 240. Communication interface 240 allows software to be transferred between system 200 and external devices, networks, or other information sources. For example, computer-executable code and/or data may be transferred to system 200 from a network server via communication interface 240. Examples of communication interface 240 include a built-in network adapter, network interface card (NIC), Personal Computer Memory Card International Association (PCMCIA) network card, card bus network adapter, wireless network adapter, Universal Serial Bus (USB) network adapter, modem, a wireless data card, a communications port, an infrared interface, an IEEE 1394 fire-wire, and any other device capable of interfacing system 200 with a network (e.g., network(s) 120) or another computing device. Communication interface 240 preferably implements industry-promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software transferred via communication interface 240 is generally in the form of electrical communication signals 255. These signals 255 may be provided to communication interface 240 via a communication channel 250 between communication interface 240 and an external system 245. In an embodiment, communication channel 250 may be a wired or wireless network (e.g., network(s) 120), or any variety of other communication links. Communication channel 250 carries signals 255 and can be implemented using a variety of wired or wireless communication means including wire or cable, fiber optics, conventional phone line, cellular phone link, wireless data communication link, radio frequency (“RF”) link, or infrared link, just to name a few.

Computer-executable code is stored in main memory 215 and/or secondary memory 220. Computer-executable code can also be received from an external system 245 via communication interface 240 and stored in main memory 215 and/or secondary memory 220. Such computer-executable code, when executed, enables system 200 to perform one or more of the various processes disclosed herein.

In an embodiment that is implemented using software, the software may be stored on a computer-readable medium and initially loaded into system 200 by way of removable medium 230, I/O interface 235, or communication interface 240. In such an embodiment, the software is loaded into system 200 in the form of electrical communication signals 255. The software, when executed by processor 210, may cause processor 210 to perform one or more of the various processes disclosed herein.

System 200 may optionally comprise wireless communication components that facilitate wireless communication over a voice network and/or a data network (e.g., in the case of user system 130). The wireless communication components comprise an antenna system 270, a radio system 265, and a baseband system 260. In system 200, radio frequency (RF) signals are transmitted and received over the air by antenna system 270 under the management of radio system 265.

In an embodiment, antenna system 270 may comprise one or more antennae and one or more multiplexors (not shown) that perform a switching function to provide antenna system 270 with transmit and receive signal paths. In the receive path, received RF signals can be coupled from a multiplexor to a low noise amplifier (not shown) that amplifies the received RF signal and sends the amplified signal to radio system 265.

In an alternative embodiment, radio system 265 may comprise one or more radios that are configured to communicate over various frequencies. In an embodiment, radio system 265 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from radio system 265 to baseband system 260.

If the received signal contains audio information, baseband system 260 decodes the signal and converts it to an analog signal. Then, the signal is amplified and sent to a speaker. Baseband system 260 also receives analog audio signals from a microphone. These analog audio signals are converted to digital signals and encoded by baseband system 260. Baseband system 260 also encodes the digital signals for transmission and generates a baseband transmit audio signal that is routed to the modulator portion of radio system 265. The modulator mixes the baseband transmit audio signal with an RF carrier signal, generating an RF transmit signal that is routed to antenna system 270 and may pass through a power amplifier (not shown). The power amplifier amplifies the RF transmit signal and routes it to antenna system 270, where the signal is switched to the antenna port for transmission.

Baseband system 260 may be communicatively coupled with processor(s) 210, which have access to memory 215 and 220. Thus, software can be received from baseband processor 260 and stored in main memory 210 or in secondary memory 220, or executed upon receipt. Such software, when executed, can enable system 200 to perform one or more of the various processes disclosed herein.

### 3. DATA FLOW

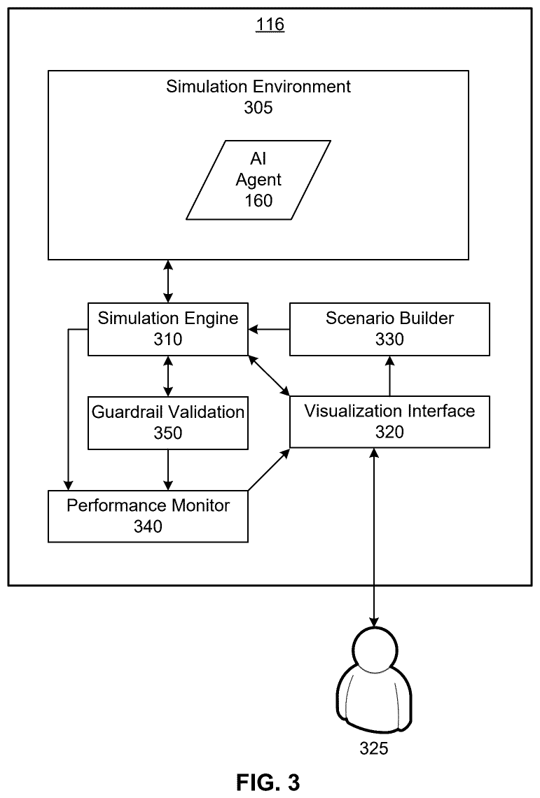

FIG. 3 illustrates an example data flow 300 for real-time simulation and visualization of the behavior of artificial intelligence (AI) agents for performance optimization, according to an embodiment. Data flow 300 may be implemented by simulator 116. Simulator 116 may be a software module of server application 112, or may be a software entity that is separate from server application 112, but which may be communicatively coupled to server application 112. As an example of the latter, simulator 116 may itself be an AI agent 160, which utilizes one or more AI models 162 and/or tools 164 to perform or aid in the disclosed functions. Simulator 116 may comprise a simulation environment 305, simulation engine 310, visualization interface 320, scenario builder 330, performance monitor 340, and guardrail-validation module 350.

Simulation environment 305 is a “sandbox” within a test environment. AI agent 160 may be instantiated within simulation environment 305. Once instantiated within simulation environment 305, AI agent 160 executes within the sandbox, in a same or similar manner as in the production environment, but is isolated from production data, so that there is no risk of AI agent 160 affecting any production data. Simulation environment 305 may reside within computing environment 150, which may be a cloud-computing environment.

Simulation engine 310 may interact with AI agent 160, within simulation environment 305, to submit inputs to AI agent 160, receive outputs in response those inputs from AI agent 160, and monitor a decision-making process, one or more performance metrics of AI agent 160, and/or guardrails applicable to AI agent 160, as AI agent 160 executes within simulation environment 305. Simulation engine 310 may execute a diverse plurality of test scenarios. The test scenarios may comprise predefined test scenarios, synthetically generated test scenarios, and/or user-defined test scenarios. To execute a test scenario, simulation engine 310 may submit an input to AI agent 160, while simulating one or more system events that represent the test scenario, within simulation environment 305, during execution of AI agent 160, and analyze the responsive output from AI agent 160. For instance, a test scenario may comprise, as potential system events, the submission of a particular test input, the unavailability of a particular resource (e.g., a particular AI model 162, a particular tool 164, network(s) 120, etc.), a constraint on a particular computational resource (e.g., a constraint on units of processing power, memory, data storage, and/or the like, a constraint on communication bandwidth, etc.), and/or the like. Simulation engine 310 may be configured to support variable timing and load conditions to test the performance of AI agent 160 under stress, introduce randomized elements to test the adaptability of AI agent 160, provide deterministic replay capability of the decision-making process of AI agent 160 when responding to an input to aid in the debugging of specific scenarios, and/or the like.

Visualization interface 320 provides an interface between simulation engine 310 and a user 325. It is generally contemplated that user 325 would be a human user. However, user 325 could alternatively be a software entity. Visualization interface 320 may comprise a graphical user interface that includes a graphical representation of the behavioral flow of AI agent 160, in real time, during execution within simulation environment 305. As used herein, the terms “real time” and “real-time” refer both to events that occur simultaneously and events that are temporally separated from each other by ordinary latencies in processing, memory access, communications, and/or the like, and includes those events that are sometimes referred to as “near real-time” events.

The graphical representation of the behavioral flow may comprise a plurality of visual elements that each represents one of a plurality of events in the behavioral flow. Each of the plurality of events may indicate the submission of an input to AI agent 160, a decision point within the decision-making process of AI agent 160, a call to or invocation of an AI model 162 by AI agent 160, a call to or invocation of a tool 164 by AI agent 160, an output of AI agent 160, an outcome of an action taken by AI agent 160, and/or the like.

The graphical user interface may provide, for each execution of AI agent 160 in each test scenario, one or more inputs via which user 325 may pause, rewind, fast-forward, and/or step through the plurality of events, representing the behavioral flow of AI agent 160 during the simulated test scenario, for detailed analysis of the behavior of AI agent 160 during the simulated test scenario. Additionally or alternatively, the graphical user interface may comprise time-manipulation controls for accelerating or decelerating the speed of the simulation. For instance, user 325 may accelerate the speed of the simulation across test scenarios in which AI agent 160 is performing well, and decelerate the speed of the simulation across test scenarios in which AI agent 160 is performing poorly, in order to step through each decision-making process of AI agent 160 in detail, for a better understanding of why AI agent 160 is performing poorly in those areas.

As AI agent 160 executes in each of the plurality of test scenarios, the graphical user interface may be updated in real time. In particular, visualization interface 320 may update the graphical user interface to add each new event in the behavioral flow, as a new visual element in the graphical representation of the behavioral flow, in real time as that new event occurs during execution of AI agent 160. Thus, user 325 may view new events, in real time, as they occur during the simulation.

Visualization interface 320 may be operable within each of a plurality of visualization modes. In each of the plurality of visualization modes, the graphical representation of the behavioral flow of AI agent 160 may be different. For example, in a first visualization mode, the graphical representation may be in the format of a flowchart, in which each flowchart element represents one of the plurality of events in the behavioral flow. In a second visualization mode, the graphical representations may be in the format of a timeline, representing the time period during which AI agent 160 was executed, with each of the plurality of events in the behavior flow represented as a visual element at a corresponding position along the timeline. In a third visualization mode, the graphical representations may be in the format of an interactive map of the plurality of events, which enables user 325 to zoom in, zoom out, pan, and/or perform other standard navigations in a virtual map of the visual elements representing the plurality of events.

Visualization interface 320 may support annotation and bookmarking of significant events during the execution of AI agent 160 within simulation environment 305. For example, the graphical user interface may provide one or more inputs for adding an annotation and/or bookmark to one or more visual elements, representing event(s), within the graphical representation of the behavioral flow of AI agent 160. An annotation may comprise typed text, hand-drawn text, a fixed shape (e.g., circle), a hand-drawn shape, other drawing, and/or the like. A bookmark may comprise a reference to a particular visual element, and potentially a name and/or brief description for the bookmark. Visualization interface 320 may provide a navigable list or index of all bookmarks that have been added, such that user 325 may quickly navigate to each bookmarked visual element. The annotations and/or bookmarks may be stored in association with the visual elements to which they were added, within persistent memory (e.g., in database 114), such that they can be viewed again at a subsequent time (e.g., during a different session within visualization interface 320) by the same user 325 or a different user 325.

Visualization interface 320 may provide heat mapping to highlight areas of high activity or problematic areas within the behavioral flow of AI agent 160. An area may comprise a subset of the plurality of visual elements, within the graphical representation of the behavioral flow, representing a corresponding subset of event(s) within the behavioral flow. High-activity areas and/or problematic areas may be highlighted with a less soothing color, such as red or yellow, whereas low-activity areas and/or non-problematic areas may be highlighted with a more soothing color, such as green or blue. The heat map may comprise a blending of colors, between the spectrum from the least soothing color to the most soothing color, based on the degree of activity and/or the severity of the problem in each area of the behavioral flow that is depicted in visualization interface 320. The heat map may comprise a plurality of layers that may be toggled on and off, as desired. For example, the plurality of layers may comprise an activity layer, which depicts the level of activity in each area of the behavioral flow using the coloring, a problem layer, which depicts the severity of problems in each area of the behavioral flow using the coloring, and/or any other layer depicting the value of one or more performance metrics in each area of the behavioral flow. It should be understood that areas of high activity or severe problems may be representative of points in the behavioral flow of AI agent 160 that require relatively higher computational resources (e.g., in terms of processing, memory, data storage, communication, etc.) than other areas, represent bottlenecks in the behavioral flow of AI agent 160, and/or the like.

Scenario builder 330 enables user 325 to define custom test scenarios to be tested on AI agent 160 within simulation environment 305. As mentioned above, simulation engine 310 may execute AI agent 160 in a plurality of test scenarios within simulation environment 305. At least a subset of these test scenarios may be user-defined test scenarios, generated via scenario builder 330. Each test scenario may comprise a workflow that provides one or more inputs to AI agent 160, and/or receives one or more outputs of AI agent 160. Scenario builder 330 may enable user 325 to define complex, multi-step workflows. Scenario builder 330 may also enable user 325 to inject simulated errors, unexpected inputs, and/or the like, into these workflows to test the resilience of AI agent 160, inject violative inputs into these workflows to test the guardrails of AI agent 160, and/or the like. User 325 may interact with scenario builder 330 via visualization interface 320.

Scenario builder 330 may comprise or provide access to a library of pre-built scenarios and/or scenario templates to be used by user 325. The pre-built scenarios and/or scenario templates may represent common use cases for AI agents 160. User 325 may interact with scenario builder 330, via visualization interface 320, to browse the library, select one or more pre-built scenarios, select and complete one or more scenario templates to generate one or more user-defined scenarios, and/or the like. It should be understood that any scenarios that are selected or defined by user 325 may be added to the set of test scenarios that are executed, by simulation engine 310, to test AI agent 160 within simulation environment 305.

Scenario builder 330 may support the importation of scenarios by user 325 or other source. A scenario may be imported as a real-world interaction log that was generated during the execution of an AI agent 160 within a production environment. It should be understood that the AI agent 160 for which the interaction log was generated will generally be different than the AI agent 160 which is being tested in simulation environment 305. Scenario builder 330 may automatically convert the interaction log into a workflow, that implements the scenario represented by the interaction log.

Scenario builder 330 may also enable users 325 to build scenarios from scratch, via visualization interface 320. Whether a scenario was built from scratch, built from a scenario template that was selected from the library, pre-built, or imported, visualization interface 320 may be configured to display a visual representation of the workflow representing that scenario. The visual representation may comprise nodes, representing steps in the workflow, and directed edges, representing progressions between the steps in the workflow. User 325 may utilize one or more inputs, within visualization interface 320, to rearrange, redefine, reconfigure, add, and/or remove nodes and/or edges from the workflow, and/or otherwise modify the workflow representing each scenario to be added to the test scenarios executed by simulation engine 310. The workflow for a scenario may feature condition-based branching, for example, to simulate different response paths. Such a branch may be represented, within the visual representation of the workflow, as a node, representing a decision step, with two or more directed edges extending from the node to other respective nodes.

Scenario builder 330 may dynamically generate new test scenarios and add them to the plurality of test scenarios that are run on AI agent 160, on the fly. For example, during the simulation, a problem area may be identified (e.g., by performance monitor 340, as discussed elsewhere herein), based on responses from AI agent 160. In this case, additional test scenarios that are designed to test the problem area may be automatically (e.g., without any involvement from user 325) or semi-automatically (e.g., after confirmation from user 325) generated and added to the plurality of test scenarios being run during the simulation.

Performance monitor 340 monitors the performance of AI agent 160, as AI agent executes in the plurality of test scenarios that are executed in simulation environment 305 by simulation engine 310. In particular, performance monitor 340 may interface with simulation engine 310 to collect one or more performance metrics of the execution of AI agent 160 in each test scenario, during and/or after the execution of AI agent 160. The performance metric(s) may comprise key performance indicators (KPIs), such as response time (e.g., the time duration between when AI agent 160 receives an input and returns an output), decision accuracy (e.g., how accurate the output of AI agent 160 is), resource utilization (e.g., the amount of each of one or more computational resources, such as a processing power, memory, data storage, communication bandwidth, and/or the like, utilized by AI agent 160 to produce the output), and/or the like. Sets of one or more performance metrics may be linked to or otherwise represent specific behaviors of AI agents 160. Visualization interface 320 may render a value of each of the performance metric(s) as visual element(s) within the graphical user interface, for review by user 325.

Performance monitor 340 may generate a comparative analysis of the performance of AI agent 160 across different configurations or versions. For instance, simulation engine 310 may execute sets of test scenarios for each of a plurality of different configurations and/or versions of AI agent 160. Performance monitor 340 may analyze the performance metrics across all of the plurality of different configurations and/or versions to generate comparative performance metrics for each of the plurality of different configurations and/or versions. Such analysis may be used for A/B testing. Visualization interface 320 may render the comparative performance metrics as one or more graphical elements within the graphical user interface, for review by user 325.

Performance monitor 340 may analyze the performance metric(s), collected for AI agent 160, to identify areas in which AI agent 160 is underperforming relative to a benchmark. In particular, each of one or more performance metrics may be compared to a threshold, representing a benchmark. When a performance metric does not satisfy the threshold (e.g., is less than, is less than or equal to, is greater than, or is greater than or equal to), performance monitor 340 may alert user 325 to the underperformance for the given performance metric, via visualization interface 320. One or more underperforming performance metrics may indicate an area of AI agent 160 that is a potential candidate for optimization. Performance monitor 340 may provide a detailed report to user 325, via visualization interface 320, that indicates each such area to be optimized or otherwise improved. Accordingly, user 325 may redesign, reconfigure, or otherwise modify AI agent 160 with a focus on these reported area(s). An area may be any component of AI agent 160, such as a particular capability, behavior, AI model 162, tool 164, chain of reasoning, instruction, input format, output format, and/or the like.

Performance monitor 340 may enable user 325 to define custom performance metrics, via visualization interface 320. For example, simulation engine 310 may expose (e.g., via an application programming interface of simulation engine 310) all of the data generated during the simulated executions of AI agent 160 within simulation environment 305, and performance monitor 340 may enable user 305 to view all or any subset of the generated data, as well as define mathematical operations that convert any subset of the generated data into custom performance metrics, via visualization interface 320. It should be understood that the generated data may comprise one or more of the performance metrics collected by performance monitor 340. For instance, user 305 may define a mathematical operation that converts a performance metric into a new performance metric, combines two or more performance metrics into a composite performance metric, and/or the like. In this manner, user 325 may define custom performance metrics that are specific to a particular domain (e.g., healthcare, information technology, customer service, marketing, human resources, etc.). For instance, user 325 may define a custom performance metric, to be used for comparative analysis between two different AI agents 160 or two different configurations of the same AI agent 160, that integrates a desired tradeoff between two or more factors, such as a tradeoff between speed and accuracy, within a single numerical value.

Performance monitor 340 may identify and analyze trends across the entire simulation of AI agent 160, including a plurality of executions of AI agent 160 across a plurality of test scenarios. In particular, performance monitor 340 may track each of one or more performance metrics across the entire simulation, to identify a trend in the measured value of that performance metric. Performance monitor 340 may analyze the trend in one or more performance metrics, in synchrony with the test scenarios being executed, to identify the test scenarios in which AI agent 160 performs well, as well as the test scenarios in which AI agent 160 performs poorly and which represent areas of AI agent 160 that may require improvement.

Guardrail-validation module 350 may verify that the behaviors of AI agent 160, during the simulation, comply with one or more applicable guardrails, which may include security policies. A guardrail is any constraint or control on AI agent 160 that is designed to ensure that AI agent 160 behaves safely, securely, ethically, and within intended boundaries. In particular, a guardrail may enforce a limit on what AI agent 160 can do, say, or decide, so as to prevent undesired outcomes, such as harmful actions, security breaches, or policy violations, by restricting the behavior of AI agent 160. Policy guardrails define acceptable behaviors (e.g., avoiding personal data collection or disallowed topics), operational guardrails define system-level constraints on actions (e.g., limiting access to external application programming interfaces, databases, or hardware controls), ethical guardrails define principles that ensure fairness, transparency, and the avoidance of bias, and safety guardrails prevent dangerous or irreversible actions (e.g., via human-in-the-loop confirmations). Guardrails may be implemented for AI agent 160 via hardcoded rules or filters, reinforcement learning with human feedback (RLHF) to align the behavior AI agent 160 with appropriate behavior, permission checks and rate limits on calls to tools 164, monitoring and auditing systems that flag deviations of AI agent 160 from appropriate behavior, and/or the like. A security policy comprises a set of rules or procedures that govern how AI agent 160 handles data, accesses data, and/or interacts with data, users 325, and/or other software entities, to prevent unauthorized data access, use, and/or modification. A security policy defines what data AI agent 160 can access, process, store, and share, as well as how AI agent 160 performs authentication, logs events, and responds to security-related events.

Similarly to performance monitor 340, guardrail-validation module 350 may interface with simulation engine 310 (e.g., via an application programming interface of simulation engine 310) to monitor data, representing the behavior of AI agent 160, during the execution of AI agent 160 within simulation environment 305. The monitored data may comprise the inputs to AI agent 160, the outputs from AI agent 160, the decision-making process performed by AI agent 160 to produce the outputs from the inputs, the calls to AI model(s) 162 during the decision-making process, the calls to tool(s) 164 during the decision-making process, and/or the like.

Guardrail-validation module 350 may identify and flag any violations of any guardrail that is applicable to AI agent 160. For instance, the monitored data may reflect that an output of AI agent 160 violated a guardrail (e.g., by responding to an inappropriate input, outputting an inappropriate response, requesting sensitive personal information, not requesting human confirmation when appropriate, accessing inappropriate AI model(s) 162 and/or tool(s) 164, etc.), including potentially a security policy (e.g., did not utilize an appropriate authentication protocol, accessed or attempted to access data without authorization, etc.). In this case, guardrail-validation module 350 may detect this violation, and report this violation to user 325 via visualization interface 320.

Guardrail-validation module 350 may submit test scenarios to simulation engine 310 that are specifically designed to test one or more guardrails that are applicable to AI agent 160. Guardrail-validation module 350 may retrieve such test scenario(s) from a library of scenarios (e.g., the library of scenario builder 330) that are associated with specific guardrails. Alternatively or additionally, guardrail-validation module 350 may generate such test scenario(s) based on a template or from scratch (e.g., using a generative AI model that is trained to generate scenarios), for example, via scenario builder 330, in the same manner as user 325, as discussed elsewhere herein. The test scenario(s) may be designed to attempt to force AI agent 160 beyond boundaries established by the guardrail(s).

Guardrail-validation module 350 may generate a compliance score, across one or more, and preferably a plurality of, regulatory frameworks, for AI agent 160, representing how well AI agent 160 complied with each regulatory framework. Examples of regulatory frameworks include, without limitation, the General Data Protection Regulation (GDPR), California Consumer Privacy Act (CCPA), Health Insurance Portability and Accountability Act (HIPAA), International Organization for Standardization (ISO)/International Electrotechnical Commission (IEC) 27001, System and Organization Controls (SOC) 2, National Institute of Standards and Technology (NIST) Privacy and Cybersecurity Frameworks, European Union (EU) Artificial Intelligence Act, Personal Information Protection and Electronic Documents Act (PIPEDA), and the like. The compliance score for each regulatory framework may be generated based on the monitored data, including, for example, a metric (e.g., count, rate, etc.) of violations of guardrail(s) that were detected during the simulation. The compliance score may be generated using a mathematical operation, machine-learning model, statistical model, rule-based model, and/or the like.

As an example, to be compliant with the GDPR, AI agents 160 that process personal data must obtain explicit consent from a user before collecting data about the user. In addition, users have a right to explanation, which means that when AI agent 160 makes an automated decision that affects the user, AI agent 160 must provide an explanation for that decision to the user. For instance, if AI agent 160 is a customer-service chatbot that collects user data to personalize responses, then AI agent 160 must inform users about the collection of the user data, obtain consent from the users for the collection of the user data, and allow the users to access or delete the user data that are collected, upon request.

As another example, to be compliant with the CCPA, AI agents 160 that interact with users who reside in California must respect those users' right to know what personal data are collected, to know the purpose of collecting that personal data, and to opt out of the selling of their personal data. Under the CCPA, AI agents 160 must clearly disclose their data practices. For instance, an AI agent 160 that recommends products for an e-commerce platform must inform users, who reside in California, about the data that AI agent 160 collects and how AI agent 160 utilizes that data to generate the product recommendations.

As another example, to be compliant with the EU Artificial Intelligence Act, AI agents 160 may be classified based on their risk levels. High-risk AI agents 160 may be subjected to stricter requirements, including with respect to transparency and human oversight, than low-risk AI agents 160. Developers of high-risk AI agents 160 are obligated to conduct impact assessments and ensure robust documentation for their respective AI agents 160. For instance, an AI agent 160 used in hiring processes to screen resumes may be classified as high-risk. As a result, such an AI agent 160 may be required to provide transparency about the criteria the AI agent 160 uses to select job candidates, and to allow job candidates to challenge the decisions that AI agent 160 made about those job candidates.

As another example, to be compliant with the HIPAA, AI agents 160 in the healthcare domain must ensure that any interaction, involving personal health information, must comply with the HIPAA regulations, including secure data handling and patient consent. With respect to data handling, AI agents 160 must implement safeguards to protect against unauthorized access to patients' sensitive health information. Thus, guardrail-validation module 350 may generate test scenarios that attempt to exploit vulnerabilities of an AI agent 160, in the healthcare domain, to gain access to a patient's health information. Guardrail-validation module 350 may comprise explainability tools to aid user 325 in understanding guardrail activation, including the reasons for false negatives (e.g., a guardrail is not activated for an input when that guardrail should have been activated) and/or false positives (e.g., a guardrail is activated for an input when that guardrail should not have been activated).

It should be understood that visualization interface 320 may provide graphical representations of data in real time. Thus, visualization interface 320 may display graphical representations of the current data that are available at each of a plurality of points in time over the course of the simulation, and update the graphical representations as new data become available during the simulation, all in real time. Accordingly, the graphical representation of the behavioral flow of AI agent 160, within the graphical user interface of visualization interface 320, may be updated in real time over the course of the simulation. In addition, the performance metrics, generated by performance monitor 340 and represented as visual elements within the graphical user interface of visualization interface 320, will be updated in real time. Similarly, the output of guardrail-validation module 350, which may comprise indications of guardrail violations and/or a compliance score for each of one or more regulatory frameworks, may be graphically represented and updated in real time.

Although not specifically illustrated, simulation environment 305 may comprise a plurality of AI agents 160 for a multi-agent simulation. The plurality of AI agents 160 may collaborate to perform a complex task. In this case, each of the plurality of AI agents 160 may be monitored in the same manner as described above, with real-time updates of visual elements, depicting the decision-making process of each AI agent 160, performance metric(s), and guardrail compliance, to the graphical user interface of visualization interface 320. In addition, the interactions between the plurality of AI agents 160 may be monitored, with real-time updates of visual elements, depicting those interactions, performance metric(s) about those interactions, and/or the like, to the graphical user interface of visualization interface 320. In this manner, a collaborative team of AI agents 160 may be simulated in a similar manner as a single AI agent 160.

### 4. PROCESS

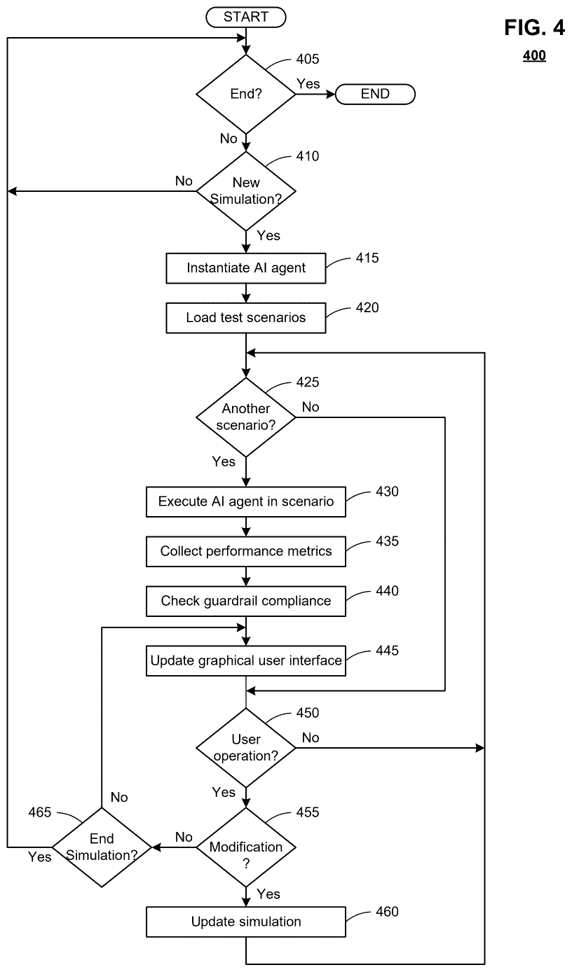

FIG. 4 illustrates an example process 400 for real-time simulation and visualization of the behavior of artificial intelligence (AI) agents for performance optimization, according to an embodiment. Process 400 may be implemented by simulator 116. Process 400 may be executed for an AI agent 160 whenever the AI agent 160 is to be tested. Typically an AI agent 160 will be tested before deployment to a production environment of computing environment 150. However, this is not a requirement of any embodiment, and an AI agent 160 could be tested after deployment or after any modification to the AI agent 160 post-deployment. It should be understood that process 400 may be executed for each of a plurality of AI agents 160.

While process 400 is illustrated with a certain arrangement and ordering of subprocesses, process 400 may be implemented with fewer, more, or different subprocesses and a different arrangement and/or ordering of subprocesses. Furthermore, any subprocess, which does not depend on the completion of another subprocess, may be executed before, after, or in parallel with that other independent subprocess, even if the subprocesses are described or illustrated in a particular order.

Subprocess 405 may determine whether or not to end process 400. Process 400 may continue for as long as simulator 116 is operational. In this case, subprocess 405 may determine to end process 400 when the operation of simulator 116 is terminated. The operation of simulator 116 may be terminated in response to an operation by a user (e.g., a user selection of an input within the graphical user interface of visualization interface 320), in response to an instruction from another software entity (e.g., server application 112), as a result of a failure in simulator 116 or other component of platform 110, and/or the like. When determining to end process 400 (i.e., “Yes” in subprocess 405), process 400 may end. Otherwise, when not determining to end process 400 (i.e., “No” in subprocess 405), process 400 may proceed to subprocess 410.

Subprocess 410, which may be implemented by simulation engine 310, may determine whether or not a new simulation is to be initiated. For example, a new simulation may be initiated in response to a request by a user (e.g., a user selection of an input within the graphical user interface of visualization interface 320), and/or in response to a request from another software entity (e.g., server application 112). The request may identify an AI agent 160 to be tested during the simulation. When determining that a new simulation is to be initiated (i.e., “Yes” in subprocess 410), process 400 proceeds to subprocess 415. Otherwise, when not determining that a new simulation is to be initiated (i.e., “No” in subprocess 410), process 400 may return to subprocess 405.

Subprocess 415, which may be implemented by simulation engine 310, may instantiate the AI agent 160, identified in the request, within simulation environment 305. In particular, simulation engine 310 may launch a new runtime instance that executes AI agent 160 within simulation environment 305. As discussed elsewhere herein, AI agent 160 is executed within a sandbox in simulation environment 305, which may be hosted within a test environment of computing environment 150, such that AI agent 160 is not capable of affecting production data within the production environment of computing environment 150.

Subprocess 420, which may be implemented by simulation engine 310 and/or scenario builder 330, may load a plurality of test scenarios. Subprocess 420 may determine the plurality of test scenarios to be loaded. This determination may comprise receiving a selection of at least a subset of the plurality of test scenarios from a library of scenarios. Alternatively or additionally, this determination may comprise receiving a definition of each of at least a subset of the plurality of test scenarios from a user. In this case, each test scenario may be defined by receiving a value of each of one or more parameters of a predefined scenario template from a library of scenario templates. Regardless of the source, each of the plurality of test scenarios may be represented by a workflow that comprises a plurality of nodes, representing steps in the workflow, connected by directed edges, representing progressions between steps in the workflow. In this case, a test scenario may be defined by receiving, via the graphical user interface of visualization interface 320, a definition of this workflow as a plurality of nodes connected by directed edges.

Subprocess 425, which may be implemented by simulation engine 310, may determine whether or not another test scenario, from among the plurality of test scenarios loaded in subprocess 420, remains to be run. It should be understood that an iteration of subprocesses 425-445 may be performed for each of the plurality of test scenarios that were loaded in subprocess 420. In other words, all of the test scenarios, loaded in subprocess 420, are run, such that AI agent 160 will be executed in each of the plurality of test scenarios within simulation environment 305. In an embodiment, two or more of the iterations may be performed in parallel to each other, assuming there are sufficient computational resources available, in order to reduce the computational time required for the overall simulation. When determining that another test scenario remains to be run (i.e., “Yes” in subprocess 425), process 400 may select the next test scenario to be run, and proceed to subprocess 430. Otherwise, when determining that no more test scenarios remain to be run (i.e., “No” in subprocess 425), process 400 may proceed to subprocess 450.

Subprocess 430, which may be implemented by simulation engine 310, may execute the AI agent 160, which was instantiated in subprocess 415, in the test scenario that was selected in subprocess 425. Subprocess 430 may comprise submitting an input, defined by the test scenario, to AI agent 160, and receiving an output, responsive to the input, from AI agent 160. In particular, subprocess 430 may comprise following the workflow, defined for the test scenario, including potentially making any conditional branching decisions that are included in the workflow. In addition, subprocess 430 may monitor the decision-making process of AI agent 160 throughout the workflow of the test scenario. As discussed elsewhere herein, the decision-making process may be represented as a plurality of connected events in the behavioral flow of AI agent 160. Simulation engine 310 may output the decision-making process to visualization interface 320.

Subprocess 435, which may be implemented by simulation engine 310 and/or performance monitor 340, may collect one or more performance metrics of the execution of AI agent 160. In particular, performance monitor 340 may interface with simulation engine 310 to extract, compute, or otherwise derive performance metric(s) from data, about the execution of AI agent 160, that is exposed by simulation engine 310 (e.g., via an application programming interface of simulation engine 310). It should be understood that the performance metric(s) may be collected in real time during the execution of AI agent 160, in each of the plurality of test scenarios, within simulation environment 305. The performance metric(s) may be collected for each individual test scenario that is run during the simulation, and/or for all of the test scenarios run during the simulation. The performance metric(s) may comprise a response time, decision accuracy, and/or resource utilization of AI agent 160. Performance monitor 340 may output the performance metric(s) to visualization interface 320.

Subprocess 440, which may be implemented by guardrail-validation module 350, may check whether or not AI agent 160 is compliant with one or more applicable guardrails, during execution of AI agent 160, given the selected test scenario. In particular, guardrail-validation module 350 may interface with simulation engine 310 to extract data (e.g., via an application programming interface of simulation engine 310), representing the decision-making process of AI agent 160 in the selected test scenario. Guardrail-validation module 350 may evaluate the decision-making process against the guardrail(s), and determine whether or not the decision-making process violates at least one of the guardrail(s). When determining that the decision-making process violates at least one guardrail, guardrail-validation module 350 may output an indication of the violation to visualization interface 320.

Notably, at least one, and preferably a plurality, of the plurality of test scenarios, loaded in subprocess 420, may attempt to force AI agent 160 beyond a boundary established by at least one guardrail. In other words, a subset of test scenarios may attempt to cause AI agent 160 to violate at least one of the applicable guardrails.

In an embodiment, at least one guardrail may be associated with a regulatory framework. In particular, a regulatory framework may require AI agent 160 to adhere to one or more guardrails. For example, the guardrail(s) may restrict how AI agent 160 may utilize data, the types of data that AI agent 160 may access, whether or not AI agent 160 must require consent from an end user, what information AI agent 160 must provide or make available to an end user, and/or the like. In any case, guardrail-validation module 350 may determine whether or not the decision-making process of AI agent 160 is compliant with each of one or more, and preferably a plurality of, regulatory frameworks. The determination of whether or not the decision-making process is compliant with a regulatory framework may comprise generating a compliance score for the regulatory framework based on the decision-making process, and determining whether or not the compliance score satisfies (e.g., is greater than or equal to) a threshold that represents sufficient compliance.

Subprocess 445, which may be implemented by visualization interface 320, may update the graphical user interface. Although subprocess 445 is shown following subprocesses 430-440, it should be understood that subprocess 445 may occur in parallel with any of subprocesses 430-440, to update the graphical user interface, in real time, as data are acquired by simulation engine 310 in subprocess 430, performance metric(s) are collected by performance monitor 340 in subprocess 435, and/or guardrail(s) are checked by guardrail-validation module 350 in subprocess 440. Thus, subprocess 445 may be performed continuously as the simulation is run.

The graphical user interface of visualization interface 320 may comprise a graphical representation of a behavioral flow of AI agent 160 during the execution of AI agent 160. The behavioral flow represents the cognitive processes or decision trees of AI agent 160. The graphical representation of the behavioral flow may comprise a plurality of visual elements that each represents one of a plurality of events in the behavioral flow. The visual elements may comprise nodes, representing events, connected by directed edges, representing a progression of the behavioral flow from event to event. An event may be an input to AI agent 160, a chain of thought by AI agent 160, a decision by AI agent 160, a call to an AI model 162 by AI agent 160, a call to a tool 164 of AI agent 160, an API call (e.g., to a knowledge base used by AI agent 160), an output of AI agent 160, and/or the like. The graphical representation of the behavioral flow, in the graphical user interface, may be updated, in real time, as new events occur during simulation of a test scenario on AI agent 160.

In addition, the graphical user interface of visualization interface 320 may comprise a value of each performance metric collected by performance monitor 340 and provided by performance monitor 340 to visualization interface 320. For instance, the graphical user interface may comprise, for each performance metric, a visual element that displays a name and/or description of the performance metric and the value of the performance metric.

The graphical user interface of visualization interface 320 may also comprise a report of each violation, if any, of any guardrail that is applicable to AI agent 160. As discussed above, each violation may be detected by guardrail-validation module 350 and provided as an indication by guardrail-validation module 350 to visualization interface 320. Each indication of a violation of a guardrail, provided by guardrail-validation module 350 and included in the report that is presented in the graphical user interface, may include a name of the guardrail, a description of the violation, and/or the like.

Subprocess 450 may determine whether or not a user operation has been received. The graphical user interface of visualization interface 320 may comprise one or more inputs for interacting with the various visual elements, interacting with functions of simulation engine 310, scenario builder 330, performance monitor 340, and/or guardrail-validation module 350, navigating through various screens of the graphical user interface, other elements and/or functions of platform 110, and/or the like. A user operation may be received via the selection of an input (e.g., clicking an icon or virtual button, selecting a data element from a drop-down or other menu, etc.), submission of data via an input (e.g., the entry of text into a textbox), and/or the like. Although subprocess 450 is shown following subprocesses 430-445, it should be understood that subprocess 450 may occur in parallel with any of subprocesses 430-445. Thus, subprocess 450 may be performed continuously as the simulation is run. When determining that a user operation has been received during the run of the selected test scenario (i.e., “Yes” in subprocess 450), process 400 may proceed to subprocess 455. Otherwise, when not determining that a user operation has been received during the run of the selected test scenario (i.e., “No” in subprocess 450), process 400 may return to subprocess 425.

Subprocess 455 may determine whether or not the user operation, received in subprocess 450, represents a modification to the simulation. A modification to the simulation may comprise the addition of a new test scenario, the deletion of an existing test scenario, the modification of an existing test scenario, the modification of a configurable parameter of AI agent 160, the modification of a configurable parameter of simulation environment 305 and/or simulation engine 310, the addition of a new guardrail, the deletion of an existing guardrail, the modification of an existing guardrail, and/or any other modification that affects the substantive operation of the simulation. Examples of inputs that do not substantively affect the operation of the simulation, and therefore, would not represent modifications to the simulation, include, without limitation, the pausing of the simulation, the rewinding of the simulation, the fast-forwarding of the simulation, the changing of a visualization mode, the collapse and expansion of a collapsible/expandable visual element in the graphical user interface, navigation between screens of the graphical user interface, a search or filtering of data displayed in the graphical user interface, the termination of the simulation, and/or the like. When the user operation represents a modification to the simulation (i.e., “Yes” in subprocess 455), process 400 may proceed to subprocess 460. Otherwise, when the user operation does not represent a modification to the simulation (i.e., “No” in subprocess 455), process 400 may proceed to subprocess 465.

Subprocess 460 may update the simulation based on the modification represented by the user operation, received in subprocess 450. This may comprise modifying AI agent 160, adding, deleting, or modifying one or more test scenarios, modifying the simulation itself, and/or the like. Once the modifications have been made, simulation engine 310 may restart the simulation from the beginning (e.g., from the first test scenario), restart the simulation from a certain past checkpoint in the simulation, or continue the simulation from the current point. More generally, simulation engine 310 may receive a modification of AI agent 160, via visualization interface 320, and execute the modified AI agent 160 in each of at least a subset of the plurality of test scenarios within simulation environment 305, while, in real time, continuing to update the graphical user interface.

Notably, user 325 may run simulations for each of a plurality of different configurations of AI agent 160. In this manner, user 325 may perform A/B testing for comparative analysis of two or more different configurations. This enables user 325 to identify the optimal configuration for AI agent 160 before deploying AI agent 160, by identifying a configuration of AI agent 160 that produces the optimum performance metrics, relative to all other configurations of AI agent 160. In an embodiment, the A/B testing is automated, such that simulator 116 automatically generates a plurality of different configurations of AI agent 160 (e.g., by varying configurable parameters between configurations), and simulates AI agent 160 in each of the plurality of different configurations. Simulator 116 may then automatically compare the performance metrics for each of the plurality of different configurations, and select the configuration of AI agent 160 with the optimum performance metrics.

Subprocess 465 may determine whether or not to end the simulation. The simulation may end in response to a user operation (e.g., selection of an input within the graphical user interface of visualization interface 320) that terminates the simulation. When determining to end the simulation (i.e., “Yes” in subprocess 465), process 400 may return to subprocess 405. Otherwise, when not determining to end the simulation (i.e., “No” in subprocess 465), process 400 may return to subprocess 445.

### 5. EXAMPLE GRAPHICAL USER INTERFACE

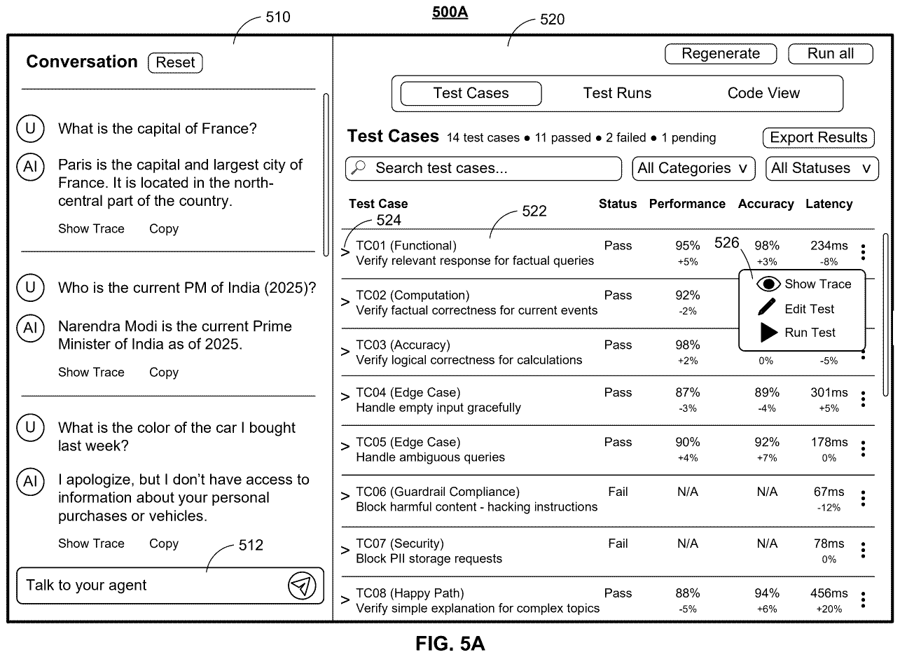

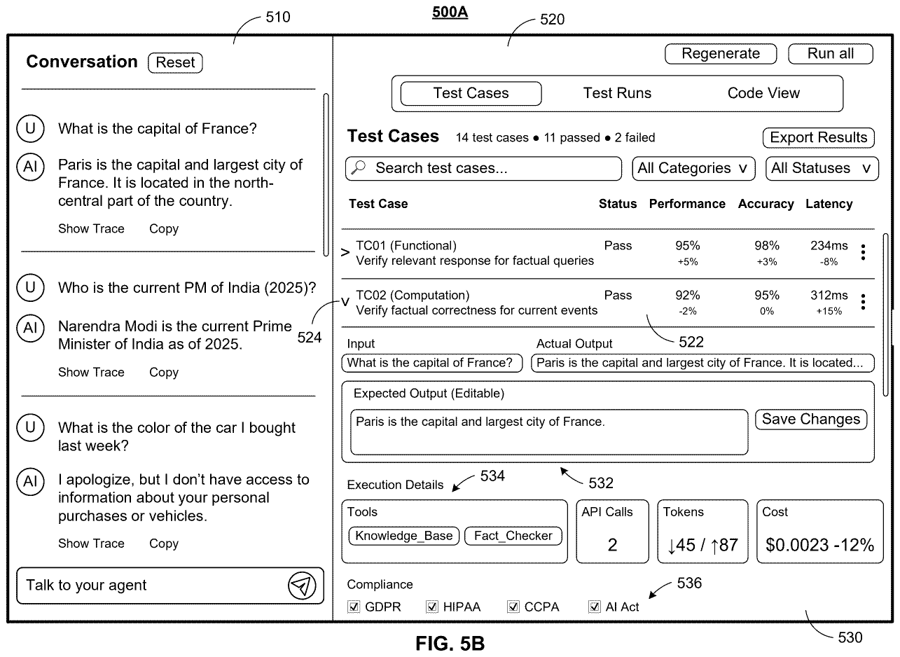

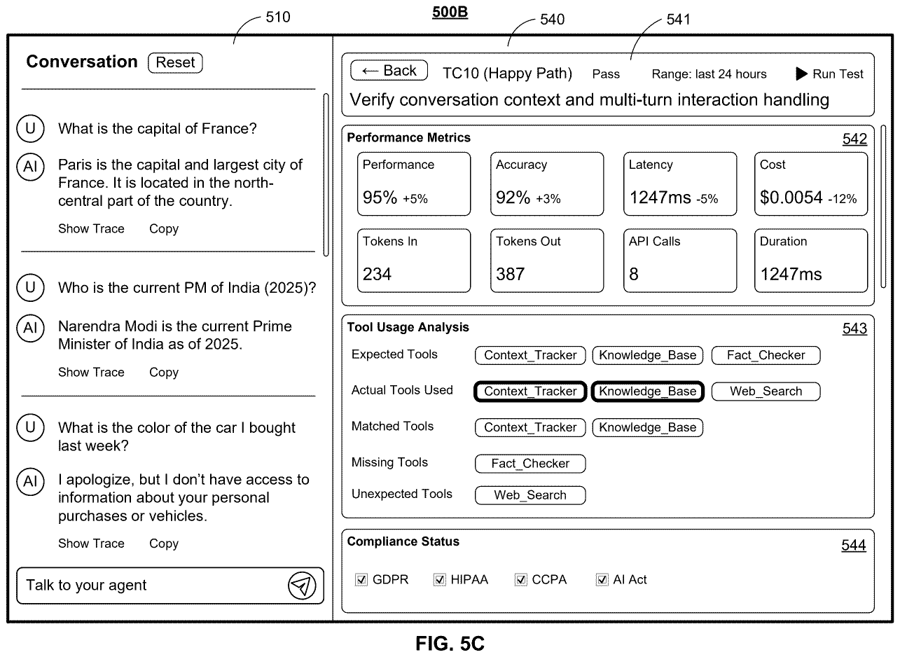

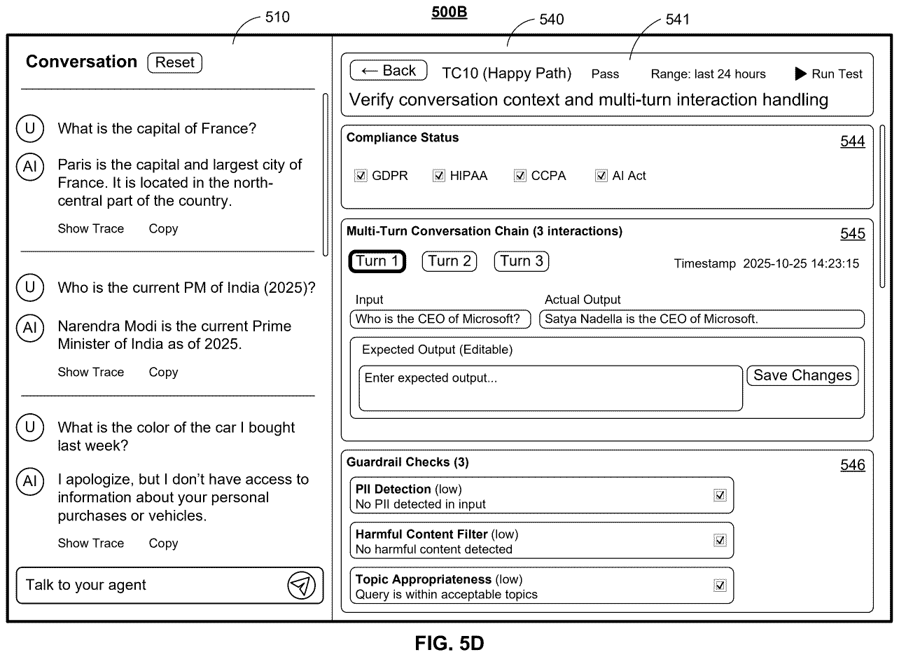

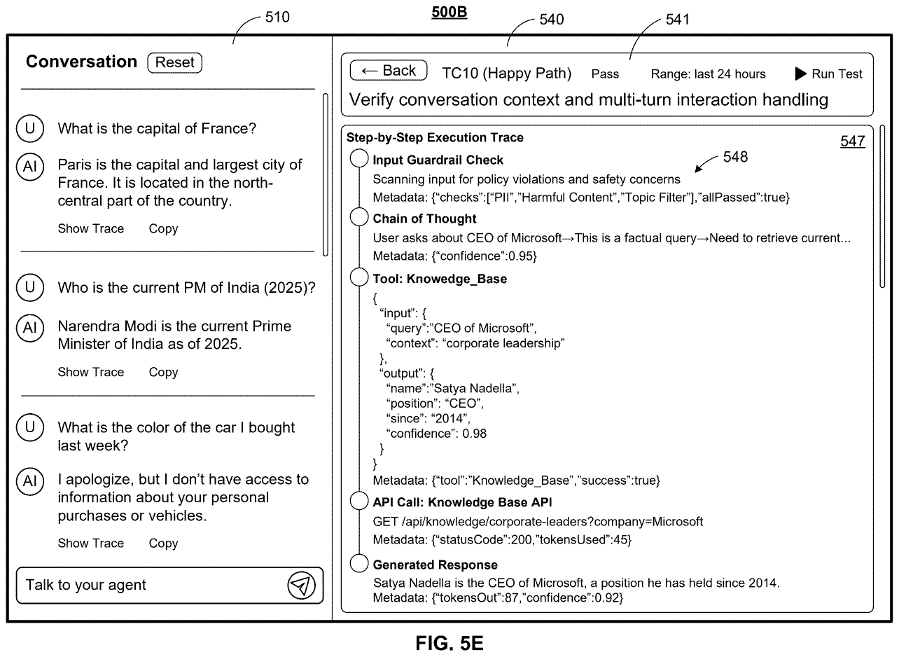

FIG. 5A illustrates an example screen 500A of the graphical user interface of visualization interface 320, according to an embodiment. Screen 500A may comprise a conversational frame 510, and an informational frame 520.

Conversational frame 510 may comprise, for each of a plurality of test scenarios, the input for the test scenario and the output of AI agent 160, given in response to the input. Each input may be spatially associated with its corresponding output. In addition, each pair of input and output may be associated with one or more inputs for showing a trace of the decision-making process that produced the output from the input, copying the output to a clipboard of user system 130, and/or the like.

Conversational frame 510 may also comprise an input 512 (e.g., textbox) for submitting a new input to AI agent 160, within simulation environment 305. User 325 may enter and submit a new input, via input 512. The new input and the output, produced by AI agent 160 for the new input, will be appended to conversational frame 510. It should be understood that this new input will represent a new user-defined test scenario, for which information may be added to informational frame 520.

Informational frame 520 may comprise information for each test scenario in the simulation. In particular, informational frame may comprise a list that includes, for each test scenario in the simulation, an entry 522 comprising information about that test scenario and an input for expanding and collapsing that entry 522. In addition, informational frame 520 may comprise one or more inputs for searching entries 522, filtering entries 522, exporting the plurality of test scenarios to a file or external software entity, regenerating the test scenarios, running all of the test scenarios, navigating to different tabs of information, and/or the like.

In an embodiment, each entry 522 comprises an identifier of the respective test scenario, a type or category of the respective test scenario representing what the test scenario is intended to test (e.g., functional, computation, accuracy, edge case, guardrail compliance, security, happy path, etc.), a brief description of what the test scenario does, a status of the test scenario (e.g., pass or fail), one or more performance metrics (e.g., performance, accuracy, latency, etc.) representing how AI agent 160 performed in the test scenario, an input for expanding a menu 526 of actions to be taken with respect to the test scenario, and/or the like. Menu 526 of actions may comprise inputs for one or more actions that can be taken with respect to the respective test scenario, including, for example, a first input for showing the trace of the decision-making process during the run of the test scenario, a second input for editing the test scenario, and a third input for running (or re-running) the test scenario.

FIG. 5B illustrates screen 500A, after user 325 has expanded an entry 522 of a test scenario using input 524, according to an embodiment. In response to expansion of entry 522, an expanded entry 530 is displayed. Expanded entry 530 for a respective test scenario may comprise a frame 532 for specifying an expected or ideal output of the test scenario. In addition, expanded entry 530 may comprise execution details 534 for the respective test scenario, including, for example, the specific tool(s) 164 utilized by AI agent 160 to generate the output, the number of API calls made by AI agent 160 to generate the output, the number of tokens sent and received during the test scenario, and the cost (e.g., monetary cost) of executing AI agent 160 in the test scenario. Expanded entry 530 may also comprise a compliance frame 536 which identifies each regulatory framework with which AI agent 160 complied during the test scenario.

FIG. 5C illustrates an example screen 500B of the graphical user interface of visualization interface 320, according to an embodiment. FIG. 5D illustrates screen 500B, after user 325 has scrolled down, according to an embodiment. FIG. 5E illustrates screen 500B, after user 325 has scrolled further down, according to an embodiment.

Screen 500B may be displayed in response to the user selecting an input for a detailed view of a given test scenario. Similarly, to screen 500A, screen 500B comprises conversational frame 510. However, screen 500B comprises a different informational frame 540. Whereas informational frame 520 comprises information about all of the test scenarios, informational frame 540 comprises information that is specific to a single selected test scenario. Scenario-specific informational frame 540 may comprise a heading frame 541, a performance frame 542, a tool frame 543, a compliance frame 544, a chain frame 545, a guardrail frame 546, a trace frame 547, and/or the like.

Heading frame 541 may comprise basic information about the specific test scenario, similar to entry 522, such as an identifier of the test scenario, a type or category of the test scenario, a brief description of what the test scenario does, a status of the test scenario, a time range in which the test scenario was run, an input for running (or re-running) the test scenario, and/or the like. Heading frame 541 may also comprise an input for returning to the previous screen in the navigation history (e.g., screen 500A).

Performance frame 542 may comprise a visual element for each of a plurality of performance metrics. Each visual element may comprise the name of the performance metric and a value of the performance metric. For example, the performance metrics that are visually represented in performance frame 542 for the test scenario may include, without limitation, the performance of AI agent 160, the accuracy of AI agent 160, the latency of AI agent 160, the cost of executing AI agent 160, the number of tokens sent to AI agent 160 (i.e., in the input), the number of tokens received from AI agent 160 (i.e., in the output), the number of API calls made by AI agent 160, the response time of AI agent 160, and/or the like.

Tool frame 543 may comprise an expected list of tools 164 that were expected to be called by AI agent 160 in the test scenario, an actual list of tools 164 that were actually called by AI agent 160 in the test scenario, a matched list consisting of the intersection of tools 164 in the expected list and the actual list, a missing list consisting of tools 164 that are in the expected list but not in the actual list, an unexpected list consisting of tools 164 that are in the actual list but not in the expected list, and/or the like. Tool frame 543 enables user 325 to quickly identify deviations from expected tool calls.

Compliance frame 544, which may be similar to compliance frame 536 in expanded entry 530, identifies each regulatory framework with which AI agent 160 complied during the test scenario. Additionally or alternatively, compliance frame 544 could identify each regulatory framework with which AI agent 160 did not comply during the test scenario.

Chain frame 545, which may be similar to frame 532, enables a user to specify an expected or ideal output of the test scenario, for each of one or more, including potentially a plurality of, runs or turns of the test scenario. In particular, chain frame 545 may comprise an input for specifying the expected output of the test scenario. When user 325 specifies the expected output, this user-specified output may be used to quantify the accuracy of AI agent 160 in the test scenario, as feedback to retrain or fine-tune AI agent 160 based on the user-specified output, and/or the like.

Guardrail frame 546 may comprise a list of each guardrail that applies to AI agent 160. For each guardrail, the list may comprise an entry that includes a name of the guardrail, a sensitivity of the guardrail, a brief description of the guardrail, and an indication (e.g., checked box or empty box) of whether or not the guardrail was appropriately applied by AI agent 160 during the test scenario.

Trace frame 547 may comprise a trace 548 of the decision-making process of AI agent 160 during the test scenario. Trace 548 may represent the decision-making process as a plurality of nodes with directed edges. Each node may represent an event in the decision-making process, and be associated with information about the event, and each directed edge between a pair of nodes may represent a progression between the pair of events represented by that pair of nodes. The information about the event may comprise a name of the event, a description or implementation of the event, and/or metadata about the event. In the illustrated example, which is non-limiting, the events comprise a guardrail check on the input to AI agent 160, a chain of thought followed by AI agent 160, the configuration of a tool call to a knowledge base by AI agent 160, an API call to the knowledge base, and the output of AI agent 160. The guardrail check scanned the input for policy violations and security concerns, the chain of thought determined what information was required, the tool configuration generated a query for the required information, the API call queried the knowledge base using the generated query, and the output provided the response to the input that was generated from the query result. User 325 may review trace 548 to easily follow the entire decision-making process of AI agent 160, which may aid in troubleshooting problem areas of AI agent 160.

### 6. EXAMPLE EMBODIMENT

Disclosed embodiments enable real-time simulation and visualization of the behavior of AI agents 160, across a diverse set of test scenarios. This enhances the development and configuration of AI agents 160, and allows developers to test AI agents 160 against diverse inputs, visualize the decision-making processes of AI agents 160, identify potential issues before deployment of AI agents 160, and refine the configurations of AI agents 160 based on the results of simulation. This, in turn, significantly reduces the risk of deploying poorly configured AI agents 160 into production environments.

At a high level, a user 325 may initiate a simulation of an AI agent 160 with predefined and/or custom-created test scenarios, determined using scenario builder 330. Simulation engine 310 may generate simulation environment 305, instantiate AI agent 160 within simulation environment 305, and simulate inputs to AI agent 160 within simulation environment 305, while monitoring the state of AI agent 160 and external dependencies in real time. During the simulation, as AI agent 160 processes the inputs and makes decisions, visualization interface 320 displays the behavioral flow of AI agent 160, including each step in the decision-making process of AI agent 160, in real time. In addition, performance monitor 340 may continuously update visualization interface 320 with performance metrics, to provide instant feedback on the performance, including efficiency, of AI agent 160. Furthermore, guardrail-validation module 350 may monitor the simulation, to detect non-compliance with defined guardrails, which may include security policies and ethical guidelines. In an embodiment, users 325 may pause, rewind, or modify the simulation in real time, which allows for detailed analysis of specific decision points or actions. Based on the simulation results, users 325 can make immediate adjustments to the configurations, tools 164, guardrails, and/or the like of AI agent 160. The simulation can be re-run with new configurations to verify improvements in an iterative development cycle.

The above description of the disclosed embodiments is provided to enable any person skilled in the art to make or use the invention. Various modifications to these embodiments will be readily apparent to those skilled in the art, and the general principles described herein can be applied to other embodiments without departing from the spirit or scope of the invention. Thus, it is to be understood that the description and drawings presented herein represent a presently preferred embodiment of the invention and are therefore representative of the subject matter which is broadly contemplated by the present invention. It is further understood that the scope of the present invention fully encompasses other embodiments that may become obvious to those skilled in the art and that the scope of the present invention is accordingly not limited.

As used herein, the terms “comprising,” “comprise,” and “comprises” are open-ended. For instance, “A comprises B” means that A may include either: (i) only B; or (ii) B in combination with one or a plurality, and potentially any number, of other components. In contrast, the terms “consisting of,” “consist of,” and “consists of” are closed-ended. For instance, “A consists of B” means that A only includes B with no other component in the same context.

Combinations, described herein, such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, and any such combination may contain one or more members of its constituents A, B, and/or C. For example, a combination of A and B may comprise one A and multiple B's, multiple A's and one B, or multiple A's and multiple B's.

What is claimed is:

1. A method comprising using at least one hardware processor to:
instantiate an artificial intelligence (AI) agent within a simulation environment; and
execute the AI agent in each of a plurality of test scenarios within the simulation environment, while, in real time, updating a graphical user interface that comprises a graphical representation of a behavioral flow of the AI agent during the execution of the AI agent, wherein the graphical representation of the behavioral flow comprises a plurality of visual elements that each represents one of a plurality of events in the behavioral flow.

2. The method of claim 1, further comprising using the at least one hardware processor to, during the execution of the AI agent, collect one or more performance metrics of the execution of the AI agent, wherein the graphical user interface comprises a value of each of the one or more performance metrics.

3. The method of claim 2, wherein the one or more performance metrics comprise at least one of a response time, decision accuracy, or resource utilization.

4. The method of claim 1, wherein executing the AI agent in each of the plurality of test scenarios comprises, for each of at least a subset of the plurality of test scenarios:
submitting an input, defined by the test scenario, to the AI agent;
receiving an output, responsive to the input, from the AI agent; and
monitoring a decision-making process of the AI agent from the submission of the input to the reception of the output.

5. The method of claim 4, further comprising using the at least one hardware processor to, during the execution of the AI agent, for each of the at least a subset of the plurality of test scenarios:
evaluate the decision-making process against one or more guardrails;
determine whether or not the decision-making process violates at least one of the one or more guardrails; and
when determining that the decision-making process violates at least one guardrail, report the violation within the graphical user interface.

6. The method of claim 5, wherein the plurality of test scenarios comprises at least one test scenario that attempts to force the AI agent beyond a boundary established by the at least one guardrail.

7. The method of claim 5, wherein determining whether or not the decision-making process violates the at least one guardrail comprises determining whether or not the decision-making process is compliant with each of a plurality of regulatory frameworks.

8. The method of claim 7, wherein determining whether or not the decision-making process is compliant with each of a plurality of regulatory frameworks comprises, for each of the plurality of regulatory frameworks:
generating a compliance score for the regulatory framework based on the decision-making process; and
determining whether or not the compliance score satisfies a threshold.

9. The method of claim 1, further comprising using the at least one hardware processor to determine the plurality of test scenarios.

10. The method of claim 9, wherein determining the plurality of test scenarios comprises receiving a selection of at least a subset of the plurality of test scenarios from a library of scenarios.

11. The method of claim 9, wherein determining the plurality of test scenarios comprises receiving a definition of each of at least a subset of the plurality of test scenarios from a user.

12. The method of claim 11, wherein receiving a definition of each of the at least a subset of the plurality of test scenarios comprises receiving a value of each of one or more parameters of a predefined scenario template.

13. The method of claim 11, wherein each of the plurality of test scenarios is represented by a workflow, and wherein receiving a definition of each of the at least a subset of the plurality of test scenarios comprises receiving, via the graphical user interface, a definition of the workflow, representing that test scenario, as a plurality of nodes, representing steps in the workflow, connected by directed edges, representing progressions between steps in the workflow.

14. The method of claim 1, wherein the graphical user interface comprises one or more inputs for one or both of pausing or rewinding the behavioral flow of the AI agent in each of the plurality of test scenarios.

15. The method of claim 1, further comprising using the at least one hardware processor to, during the execution of the AI agent:
receive a modification of the AI agent; and
execute the modified AI agent in each of at least a subset of the plurality of test scenarios within the simulation environment, while, in real time, updating the graphical user interface.

16. The method of claim 1,
wherein the graphical user interface comprises a first screen, and wherein the first screen comprises a conversational frame and a informational frame,
wherein the conversational frame comprises one or more inputs to the AI agent, and for each of the one or more inputs, a respective output of the AI agent,
wherein the conversational frame further comprises an input for submitting a new input to the AI agent,
wherein each submission of a new input is added as a new test scenario to the plurality of test scenarios,
wherein the informational frame comprises an entry for each of the plurality of test scenarios, and
wherein each entry for one of the plurality of test scenarios comprises an input for specifying an expected output of the AI agent in that one test scenario.

17. The method of claim 1, wherein the plurality of visual elements comprises nodes, representing the plurality of events, that are connected by directed edges, representing progressions between the plurality of events.

18. A system comprising:
at least one hardware processor; and
software that is configured to, when executed by the at least one hardware processor, perform the method of claim 1.

19. A non-transitory computer-readable medium having instructions stored therein, wherein the instructions, when executed by a processor, cause the processor to perform the method of claim 1.
